(19) United States
(12) Patent Application Publication
(10) Pub. No.: US 2003/0107566 A1
(43) Pub. Date: Jun. 12, 2003

(54) Display apparatus and method of supplying power to USB device thereof

(75) Inventors: Seung-Gi Shin, Suwon City (KR); Hae-Jin Hwang, Suwon-City (KR); Jong-Tae Chun, Seoul City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon City (KR)

(21) Appl. No.: 10/245,574

(22) Filed: Sep. 18, 2002

(30) Foreign Application Priority Data
Dec. 8, 2001 (KR) 2001-77666
Apr. 23, 2002 (KR) 2002-22236

(51) Int. Cl. G09G 5/00

(52) U.S. Cl. 345/212

(57) ABSTRACT

A display apparatus processing a video signal from a main body to display a picture, including a USB hub with at least one LCD USB port having a power pin through which a USB driving power is supplied from at least one USB port provided in the main body. With this configuration, a display apparatus and a method of supplying power to a USB device thereof are provided, in which power from a main body is supplied to the USB device attached to the USB hub of the display apparatus regardless of a power saving mode (the S3 mode of the ACPI).

### CROSS-REFERENCE TO RELATED APPLICATIONS

This application claims the benefit of Korean Application Nos. 2001-77666, filed Dec. 8, 2001 and 2002-22236, filed Apr. 23, 2002, in the Korean Patent Office, the disclosures of which are incorporated herein by reference.

### BACKGROUND OF THE INVENTION

1. Field of the Invention

The present invention relates to a display apparatus, and more particularly, to a display apparatus with a USB hub and a method of supplying power to a USB device thereof.

2. Description of the related Art

Generally, a computer system has a power management system to save power. Recently, an APM (advanced power management) system improved from the power management system has been developed and is being applied to the computer system. For instance, most IBM compatible computers presently employ the APM system.

On the other hand, to improve a power management and a quick process of the computer system, Intel, Microsoft, and Toshiba published an “ACPI (advanced configuration and power interface) specification revision 1.0” in Dec. 22, 1996. Recently, the ACPI is being applied to the computer system.

According to the APCI, the power management of the computer system is divided into six modes of S0˜S5. The S0 mode indicates a normal mode, the S1˜S4 modes indicate power saving modes different in a grade sequentially, and the S5 mode indicates a power off mode. A power supply of the computer system according to the ACPI supports an ATX (a motherboard specification) in which main power and standby power are divided. When external AC power is supplied, the power supply supporting the ATX outputs continuously standby power supplied to a power management controller of the computer system.

Herein, in the S3 mode of the ACPI to provide efficient power management and quick process of the computer system, power is not supplied to hardware components of the computer system except a system memory (RAM) and the power management controller. The process of bringing the computer system into the S3 mode is called “suspend to RAM,” and the last operation of the computer system is stored in the system memory when the computer system comes into the S3 mode.

When the computer system comes into the S3 mode, the ACPI allows the system memory (RAM) to store the last operation of the computer system, and the hardware components to be turned off except the system memory and the power management controller. When the computer system is turned back on from the S3 mode, the computer system is quickly restored to the last operation based on data stored in the system memory without normal booting. Thus, a user prefers the computer system supporting the S3 mode of the ACPI because of the efficient power management and the quick process.

On the other hand, the computer system comprises a main body outputting a video signal, and a monitor connected to the main body and displaying a picture based on the video signal from the main body.

The monitor may include a CRT (cathode ray tube) monitor, an LCD (liquid crystal display) monitor, etc. Recently, the LCD monitor has been widely used in spite of its relatively high price because a user experiences relatively small eyestrain using the LCD monitor.

Further, there has been developed an LCD monitor having a USB hub to which a device having a USB connector (it will be called a USB device) is attached.

However, in the conventional LCD monitor having the USB hub, i.e., a plurality of USB ports, due to the LCD monitor being operated by external AC power directly supplied thereto, power is supplied to the LCD monitor regardless of a power saving mode (e.g., the S3 mode of the ACPI) of the main body, thereby decreasing the effect of the power management system. Further, if the LCD monitor is operated by power supplied from the main body in order to solve the foregoing and other problems, the power is not supplied to the USB hub in the case of the power saving mode (e.g., the S3 mode of the ACPI), so that the computer system cannot be woken up from the power saving mode by the device attached to the USB hub.

### SUMMARY OF THE INVENTION

Accordingly, it is an object of the present invention to provide a display apparatus and a method of supplying power to a USB device thereof, in which power from a main body is supplied to the USB device attached to a USB port provided in a USB hub of the display apparatus regardless of a power saving mode (e.g., an S3 mode of the ACPI).

Additional objects and advantages of the invention will be set forth in part in the description which follows and, in part, will be obvious from the description, or may be learned by practice of the invention.

The foregoing and other objects of the present invention are achieved by providing a display apparatus processing a video signal from a main body so as to display a picture, comprising at least one USB port having a power pin through which a USB driving power is supplied from at least one USB port provided in the main body.

In an aspect of the present invention, the display apparatus further comprises a power input port receiving a driving power from a power output port provided in the main body, wherein the driving power transmitted to the power input port is supplied to a USB device attached to the at least one USB port provided in the display apparatus when the main body is in a normal mode, and the USB driving power outputted from a USB port provided in the main body is supplied to the at least one USB port provided in the display apparatus when the driving power is not supplied to the power input part as the main body enters into a power saving mode.

In an aspect of the present invention, the display apparatus further comprises a USB controller controlling the USB device attached to the at least one USB port provided in the display apparatus, and a USB power supply generating a driving power for the USB controller by transforming the driving power outputted from the USB port of the main body, wherein the USB controller is operated by the driving power received from the USB power supply and controls the USB device attached to the at least one USB port of the display apparatus in the power saving mode, when the driving power is not supplied to the power input port.

In another aspect of the present invention, the display apparatus further comprises a reverse current preventing circuit, which is electrically connected to the USB power supply and prevents a counter current.

In another aspect of the present invention, the USB controller transmits a wake-up signal to the main body so as to wake up the main body from the power saving mode when the USB controller receives a user input signal from the USB device in the power saving mode.

The foregoing and other objects of the present invention may be also achieved by providing a method of supplying power to a USB device of a display apparatus having at least one USB port to which the USB device is attached, the at least one USB port being provided with a power pin, the method comprising: supplying a driving power from a main body to the at least one USB port of the display apparatus.

Here, the display apparatus further comprises a USB controller controlling the USB device attached to the at least one USB port of the display apparatus, and a USB power supply generating a driving power for the USB controller by transforming the driving power outputted from the main body, wherein the supplying the driving power to the at least one USB port of the display apparatus comprises: supplying the driving power from a power output port of the main body to the at least one USB port of the display apparatus when the main body is in a normal mode; and supplying a USB driving power outputted from a USB port provided in the main body to the USB device attached to the at least one USB port of the display apparatus when the driving power is not supplied from the power output port as the main body enters into a power saving mode.

In another aspect of the present invention, the method further comprises: detecting a user input signal from the USB device attached to the at least one USB port of the display apparatus in the power saving mode; and transmitting a wake-up signal to the main body through the USB port provided in the main body when the user input signal from the USB device is detected.

The foregoing and other objects may be also achieved by providing a display apparatus processing a video signal from a main body so as to display a picture, comprising: at least one USB port receiving a user input signal; and a controller controlling communication between the main body and the display apparatus in response to the user input signal through the at least one USB port of the display apparatus, the controller receiving a driving power from a USB port provided in the main body.

In another aspect of the present invention, the display apparatus further comprises a power input port receiving a driving power from a power output port provided in the main body, wherein the driving power transmitted to the power input port is supplied to a USB device attached to the at least one USB port provided in the display apparatus when the main body is in a normal mode, and the USB driving power is outputted from the USB port provided in the main body and is supplied to the at least one USB port provided in the display apparatus when the driving power is not supplied to the power input port as the main body enters into a power saving mode.

In another aspect of the present invention, the display apparatus further comprises a USB power supply generating a driving power for the controller by transforming the driving power outputted from the USB port of the main body, wherein the controller is operated by the driving power received from the USB power supply and controls the USB device attached to the at least one USB port in the power saving mode, when the driving power is not supplied to the power input port.

In yet another aspect of the present invention, the display apparatus further comprises a reverse current preventing circuit, which is electrically connected to the USB power supply and prevents a counter current.

In yet another aspect of the present invention, the controller transmits a wakeup signal to the main body so as to wake up the main body from the power saving mode when the controller receives the user input signal from the USB device in the power saving mode.

The foregoing and other objects may be also achieved by providing a display apparatus processing a video signal from a main body so as to display a picture, comprising a first USB port having a plurality of connector pins including a power pin, the power pin being connected to a power supply supplying power to a controller controlling the first USB port.

In another aspect of the present invention, the display apparatus further comprises a second LCD USB port receiving a video signal from the main body and having a power pin connected to the power supply of the main body, and wherein the controller receives a driving power from the power pin of the second USB port.

In another aspect of the present, the display apparatus further comprises a power input port receiving a driving power from a power output port provided in the main body, wherein the driving power transmitted to the power input port is supplied to a USB device attached to the first USB port provided in the display apparatus when the main body is in a normal mode, and the USB driving power is outputted from a USB port provided in the main body and is supplied to the first USB port provided in the display apparatus when the driving power is not supplied to the power input port as the main body enters into a power saving mode.

In another aspect of the present invention, the display apparatus further comprises a USB power supply transforming the driving power transmitted from the second USB port, wherein the controller is operated by the driving power received from the USB power supply and controls the USB device attached to the first USB port in the power saving mode, when the driving power is not supplied to the power input port.

In another aspect of the present invention, the display apparatus further comprises a reverse current preventing circuit, which is electrically connected to the USB power supply and prevents a counter current.

In another aspect of the present invention, the controller transmits a wake-up signal to the main body through the USB port in the main body so as to wake up the main body from the power saving mode when the controller receives a user input signal from the USB device in the power saving mode.

The foregoing and other objects may be also achieved by providing a connecting cable connecting a main body and a display apparatus, comprising a main body connector including at least one among a power connector, a USB connector, and a video connector; and a display apparatus connector transmitting signals from the power connector, the USB connector, and the video connector to a display apparatus.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a perspective view of a computer system with an LCD monitor as a display apparatus according to an embodiment of the present invention;

FIG. 2 is a block diagram of the LCD monitor according to an embodiment of the present invention.

### DETAILED DESCRIPTION OF THE PREFERRED EMBODIMENT

Reference will now made in detail to the embodiments of the present invention, examples of which are illustrated in the accompanying drawings, wherein like reference numerals refer to the like elements throughout. The embodiments are described below in order to explain the present invention by referring to the figures.

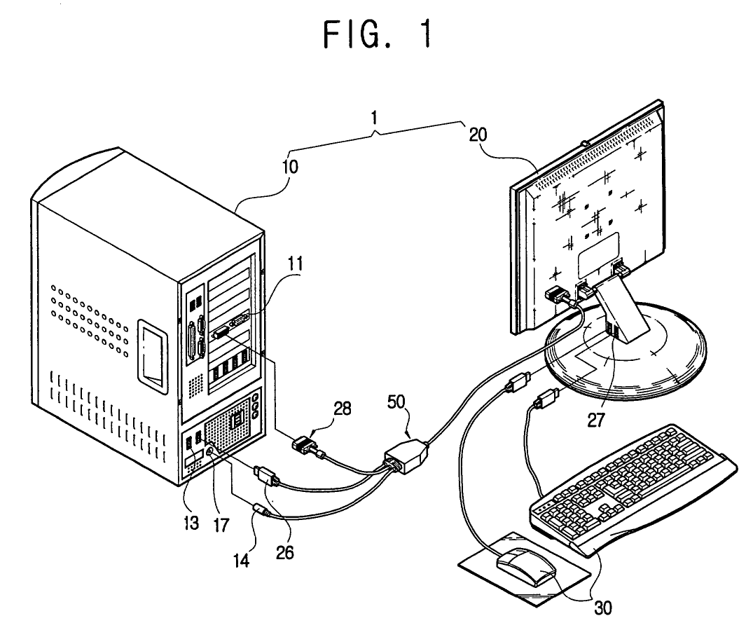

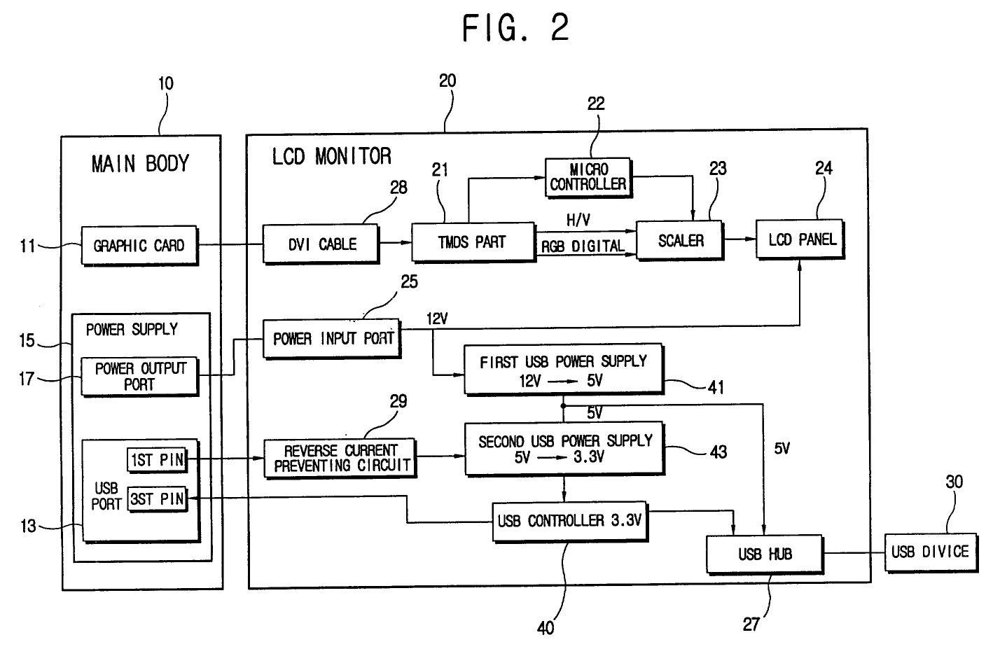

FIG. 1 is a perspective view of a computer system with an LCD monitor as a display apparatus according to an embodiment of the present invention. As shown therein, the LCD monitor 20 is connected to a main body 10 having a plurality of hardware components such as a graphic card 11, etc., and displays a picture on an LCD panel 24 thereof (see FIG. 2) by receiving a video signal from the graphic card 11. Herein, a DVI (digital video interactive) cable 50 is employed to connect the LCD monitor 20 and the main body 10. The DVI cable 50 includes a power connector 14 connected to a power output port 17, a video connector 28 connected to the graphic card 11, and a USB connector 26 connected to a USB port 13.

FIG. 2 is a block diagram of the LCD monitor according to an embodiment of the present invention. As shown in FIG. 2, the LCD monitor 20 comprises a TMDS (transition minimized differential signaling) part 21 and a scaler 23 processing a digital video signal, a micro controller 22 controlling the TMDS part 21 and the scaler 23, and the LCD panel 24 outputting the digital video signal processed by the scaler 23.

In the LCD monitor 20, a compressed digital video signal is transmitted from the main body 10 to the TMDS part 21 through the DVI cable 50. Then, the TMDS part 21 decompresses the transmitted digital video signal, and transmits horizontal/vertical synchronous signals to the micro controller 22 and the scaler 23, and RB/G signals to the scaler 23.

Then, the micro controller 22 determines the resolution of the LCD panel 24 on the basis of the horizontal/vertical synchronous signal, and transmits a control signal to the scaler 23, to thereby adjust the RG/B signals according to the determined resolution.

Then, the scaler 23 adjusts the RG/B signals to the size of the LCD panel 23 on the basis of the control signal transmitted from the micro controller 22, and outputs it to the LCD panel 24.

According to an embodiment of the present invention, the LCD monitor 20 comprises a power input port 25, a DVI cable interface, a USB hub 27 having a plurality of LCD USB ports to which a USB device 30 is attached, a USB controller 40 controlling the USB device 30 attached to the USB hub 27, and first and second USB power supplies 41 and 43 supplying power to the USB controller 40.

The power input port 25 is electrically connected to a power supply 15 of the main body 10 through a power output port 17 (see FIGS. 1 and 2). Thus, the power input port 25 receives a driving power (12V) for the LCD monitor 20 from the power supply 15 through the power output port 17.

The USB connector 26 is provided at an end of the DVI cable 50 and attached to the USB port 13 of the main body 10, so as to connect the main body with the USB device 30 (see FIG. 1) connected to the LCD monitor through the USB hub 27.

The USB hub 27 (see FIG. 1), having the plurality of LCD USB ports, is provided in the LCD monitor 20, and through which the plurality of USB devices 30 is connected. The USB device 30 receives a driving power (5V) from the main body 10 through the USB hub 27.

The USB controller 40 (see FIG. 2) is provided inside the LCD monitor 20, is electrically connected to the USB port 13 of the main body 10 through the USB connector 26, and transmits the control signal to the USB device 30 attached to the USB hub 27 so as to control communication between the USB device 30 and the main body 10.

With this configuration, when the main body 10 is in a normal mode, the power supply 15 outputs the driving power of 12V through the power output port 17 and the LCD monitor 20 receives it through the power input port 25. Inside the LCD monitor 20, the first USB power supply 41 transforms the received driving voltage of 12V into 5V and transmits it to the USB hub 27, thereby supplying the driving power to the USB device 30 attached to the USB hub 27. Further, the second USB power supply 43 receives the driving voltage of 5V from the first USB power supply 41 and supplies the driving power to the USB controller 40 after transforming it into 3.3V, thereby allowing the USB controller 40 to transmit the control signal to the USB device 30.

On the other hand, when the main body 10 is in the power saving mode, the power supply 15 does not output the driving power through the power output port 17. Therefore, the driving power is not supplied to the power input port 25 of the LCD monitor 20. Moreover, the USB hub 27 does not receive the driving power from the power input port 25.

According to an embodiment of the present invention, as shown in FIG. 2, the LCD monitor 20 comprises a reverse current preventing circuit 29 through which the driving power of 5V, outputted from a 1^{st} pin of the USB port 13 provided in the main body 10, is supplied to the USB hub 27, while the driving power outputted from the second USB power supply 43, provided in the LCD monitor 20, is not supplied to the 1^{st} pin of the USB port 13.

The reverse current preventing circuit 29 prevents a counter electromotive force, which is generated when the USB device 30 is attached to the USB hub 27, from being transmitted to the 1^{st} pin of the USB port 13 via the second USB power supply 43.

Therefore, though the main body 10 is in the power saving mode (the S3 mode of the ACPI), the driving power of 5V is supplied from the 1^{st} pin of the USB port 13 to the USB hub 27 of the LCD monitor 20 via the USB connector 26, the reverse current preventing circuit 29, and the second USB power supply 43, thereby supplying the driving power to the USB device 30.

Further, when the main body 10 is in the power saving mode (the S3 mode of the ACPI), the driving power of 5V outputted from the 1^{st} pin of the USB port 13 is transformed into 3.3V by the second USB power supply 43, and then supplied to the USB controller 40 controlling the USB device 30 attached to the USB hub 27.

Thus, though the LCD monitor 20 is turned off as the main body 10 enters into the power saving mode, the LCD monitor 20 receives the driving power for the USB device 30 from the 1^{st} pin of the USB port 13, thereby supplying the driving power to the USB device 30 and supplying the driving power transformed by the second USB power supply 43 to the USB controller 40 transmitting the control signal to the USB device 30. Therefore, when the main body 10 is in the power saving mode, because the driving power is supplied to the USB hub 27 and the USB controller 40, the USB controller 40 detects an input signal of the USB device 30 including a mouse, a keyboard, etc., and transmits a wake-up signal to the main body 10 through a 3^{rd} pin of the USB port 13 in the case where the input signal of the USB device 30 is detected, thereby waking up the main body 10 from the power saving mode.

In the foregoing embodiments, the USB controller 40 receives the driving power from the power pin of the USB port 13 of the main body 10. However, the USB controller may receive the driving power from a power pin of a USB port, which is provided in the LCD monitor and through which a video signal is inputted from the main body.

In the foregoing embodiments, the LCD monitor 20 is of a display apparatus for a desktop computer system. However, the LCD monitor may be of a display apparatus for a portable computer system.

As described above, the present invention provides a display apparatus and a method of supplying power to a USB device thereof, in which power from a main body is supplied to the USB device attached to a USB hub of the display apparatus regardless of a power saving mode (the S3 mode of the ACPI).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A display apparatus processing a video signal from a main body so as to display a picture, comprising at least one USB port having a power pin through which a USB driving power is supplied from at least one USB port provided in the main body.

2. The display apparatus according to claim 1, further comprising a power input port receiving a driving power from a power output port provided in the main body,
wherein the driving power transmitted to the power input port is supplied to a USB device attached to the at least one USB port provided in the display apparatus when the main body is in a normal mode, and the USB driving power outputted from the USB port provided in the main body is supplied to the at least one USB port provided in the display apparatus when the driving power is not supplied to the power input port as the main body enters into a power saving mode.

3. The display apparatus according to claim 2, further comprising a USB controller controlling the USB device attached to the at least one USB port provided in the display apparatus, and a USB power supply generating a driving power for the USB controller by transforming the driving power outputted from the USB port of the main body,
wherein the USB controller is operated by the driving power received from the USB power supply and controls the USB device attached to the at least one USB port of the display apparatus in the power saving mode, when the driving power is not supplied to the power input port.

4. The display apparatus according to claim 3, further comprising a reverse current preventing circuit which is electrically connected to the USB power supply and prevents a counter current.

5. The display apparatus according to claim 4, wherein the USB controller transmits a wake-up signal to the main body to wake up the main body from the power saving mode when the USB controller receives a user input signal from the USB device in the power saving mode.

6. A method of supplying power to a USB device of a display apparatus having at least one USB port to which the USB device is attached, the at least one USB port provided in the display apparatus being provided with a power pin, the method comprising:
supplying a driving power from a main body to the at least one USB port of the display apparatus.

7. The method according to claim 6, the display apparatus further comprising a USB controller controlling the USB device attached to the at least one USB port of the display apparatus, and a USB power supply generating a driving power for the USB controller by transforming the driving power outputted from the main body, wherein the supplying the driving power to the at least one USB port of the display apparatus comprises:
supplying the driving power from a power output port of the main body to the at least one USB port of the display apparatus when the main body is in a normal mode; and
supplying a USB driving power outputted from a USB port provided in the main body to the USB device attached to the at least one USB port of the display apparatus when the driving power is not supplied from the power output port as the main body enters into a power saving mode.

8. The method according to claim 7, further comprising:
detecting a user input signal from the USB device attached to the at least one USB port of the display apparatus in the power saving mode; and
transmitting a wake-up signal to the main body through a second USB port provided in the main body when the user input signal from the USB device is detected.

9. A display apparatus processing a video signal from a main body to display a picture, comprising:
at least one USB port receiving a user input signal; and
a controller controlling communication between the main body and the display apparatus in response to the user input signal through the at least one USB port of the display apparatus, the controller receiving a driving power from a USB port provided in the main body.

10. The display apparatus according to claim 9, further comprising a power input port receiving a driving power from a power output port provided in the main body,
wherein the driving power transmitted to the power input port is supplied to a USB device attached to the at least one USB port provided in the display apparatus when the main body is in a normal mode, and the USB driving power is outputted from the USB port provided in the main body and is supplied to the at least one USB port provided in the display apparatus when the driving power is not supplied to the power input port as the main body enters into a power saving mode.

11. The display apparatus according to claim 10, further comprising a USB power supply generating a driving power for the controller by transforming the driving power outputted from the USB port of the main body,
wherein the controller is operated by the driving power received from the USB power supply and controls the USB device attached to the at least one USB port provided in the display apparatus in the power saving mode, when the driving power is not supplied to the power input port.

12. The display apparatus according to claim 11, further comprising a reverse current preventing circuit which is electrically connected to the USB power supply and prevents a counter current.

13. The display apparatus according to claim 12, wherein the controller transmits a wake-up signal to the main body so as to wake up the main body from the power saving mode when the controller receives the user input signal from the USB device in the power saving mode.

14. A display apparatus processing a video signal from a main body so as to display a picture, comprising:
a first USB port having a plurality of connector pins including a power pin, the power pin being connected to a power supply supplying power to a controller controlling the first USB port.

15. The display apparatus according to claim 14, further comprising a second USB port receiving a video signal from the main body and having a power pin connected to the power supply of the main body, and
wherein the controller receives a driving power from the power pin of the second USB port.

16. The display apparatus according to claim 15, further comprising a power input port receiving a driving power from a power output port provided in the main body,
wherein the driving power transmitted to the power input port is supplied to a USB device attached to the first USB port provided in the display apparatus when the main body is in a normal mode, and the USB driving power is outputted from a second USB port provided in the main body and is supplied to the first USB port provided in the display apparatus when the driving power is not supplied to the power input port as the main body enters into a power saving mode.

17. The display apparatus according to claim 16, further comprising a USB power supply transforming the driving power transmitted from the second USB port,
wherein the controller is operated by the driving power received from the USB power supply and controls the USB device attached to the first USB port provided in the display apparatus in the power saving mode, when the driving power is not supplied to the power input port.

18. The display apparatus according to claim 17, further comprising a reverse current preventing circuit which is electrically connected to the USB power supply and prevents a counter current.

19. The display apparatus according to claim 18, wherein the controller transmits a wake-up signal to the main body through the USB port in the main body so as to wake up the main body from the power saving mode when the controller receives a user input signal from the USB device in the power saving mode.

20. A connecting cable connecting a main body and a display apparatus, comprising:
a main body connector including at least one among a power connector, a USB connector, and a video connector; and
a display apparatus connector transmitting signals from the power connector, the USB connector, and the video connector to a display apparatus.

21. An LCD monitor used with a computer main body, comprising:
a power input port to receive power from a power supply of the computer main body and output the received power to a USB device when the computer body is in a wake mode; and
a reverse current preventing circuit to receive a driving power outputted from a USB port and to output the driving power to a USB device when the computer main body is in a power saving mode, and prevent power from being transmitted to the USB port.

22. The LCD monitor according to claim 21, wherein the LCD monitor further comprises a first USB power supply to supply the received power from the power input port to the USB device after transforming the received power from 12V to 5V.

23. The LCD monitor according to claim 22, wherein the LCD monitor further comprises:
a second USB power supply to transform the 5V power into 3.3V;
a USB hub having at least one LCD USB port to supply power to the USB device; and
a USB controller to control the USB hub.

24. The LCD monitor according to claim 23, wherein when the computer main body is in the wake mode, the USB controller receives the transformed 3.3V and supplies the 3.3V to the at least one LCD USB port, which in turn supplies the 3.3V to the USB device, and when the computer main body is in the power saving mode, the USB controller receives the driving power from the USB port in the main body.

25. The LCD monitor according to claim 24, wherein the USB port comprises a first pin to provide the driving power to the reverse current preventing circuit.

26. The LCD monitor according to claim 25, wherein the reverse current preventing circuit prevents a counter electromotive force generated when the USB device is attached to the at least one LCD USB port from being transmitted to the first pin of the USB port.

27. The LCD monitor according to claim 23, wherein when the computer main body is in the wake mode, the USB controller receives the transformed 3.3V and supplies the 3.3V to the at least one LCD USB port, which in turn supplies the 3.3V to the USB device, and when the computer main body is in the power saving mode, the USB controller receives the driving power from the USB port provided in the LCD monitor and through which a video signal is inputted from the main body.

28. The LCD monitor according to claim 21, wherein the LCD monitor is of a display apparatus for a desktop computer system.

29. The LCD monitor according to claim 21, wherein the LCD monitor is of a display apparatus for a portable computer system.

30. A computer comprising:
a main body to supply power; and
a display unit having a USB port to receive power from the main body,
wherein the USB port receives power from the main body regardless of whether or not the computer is in a power saving mode.

31. A method of supplying power to a display apparatus comprising:
supplying power from a main body to a USB device provided in a USB hub of the display apparatus regardless of whether or not the display device is in a power saving mode.
